(19) United States
(12) Patent Application Publication
(10) Pub. No.: US 2015/0375355 A1
(43) Pub. Date: Dec. 31, 2015

(54) INTEGRATED PART FIXTURING FOR LATHING PROCESSES

(71) Applicants: Joseph Anthony COLLINS, Carlsbad, CA (US); Vincent Vic VILLANUEVA, Lakewood, CA (US); Philip Donald GOLLER, Lake Forest, CA (US)

(72) Inventors: Joseph Anthony COLLINS, Carlsbad, CA (US); Vincent Vic VILLANUEVA, Lakewood, CA (US); Philip Donald GOLLER, Lake Forest, CA (US)

(21) Appl. No.: 14/575,833

(22) Filed: Dec. 18, 2014

Related U.S. Application Data
(60) Provisional application No. 62/017,739, filed on Jun. 26, 2014.

(51) Int. Cl. B24B 13/005; B23B 5/40; B24B 13/04

(52) U.S. Cl. CPC B24B 13/0055; B24B 13/046; B23B 5/40

(57) ABSTRACT

Methods, systems, and devices for lathing parts, including lenses such as ophthalmic lenses. In some embodiments a reference surface is machined into a workpiece. In some embodiments the methods include machining first and second surfaces of a lens so that they have the same centerlines.

### CROSS REFERENCE TO RELATED APPLICATIONS

This application claims the priority of U.S. Provisional Application No. 62/017,739, filed Jun. 26, 2014, the disclosure of which is incorporated by reference herein.

The disclosures of the following applications are incorporated by reference herein: U.S. Pat. No. 8,057,541, issued Nov. 15, 2011; U.S. Pub. No. 2008/0262610, published Oct. 23, 2008; U.S. Pub. No. 2009/0198325, published Aug. 6, 2009; and Pub. No. 2011/0218623, published Sep. 8, 2011.

### INCORPORATION BY REFERENCE

All publications and patent applications mentioned in this specification are herein incorporated by reference to the same extent as if each individual publication or patent application was specifically and individually indicated to be incorporated by reference.

### BACKGROUND

A common technique for manufacturing lenses, such as contact lenses, corneal lenses, corneal inlays, spectacles, and intraocular lenses, is to machine surfaces of the lens into a workpiece using, for example, a lathe.

FIGS. 1A-1D illustrate sectional side views of exemplary ophthalmic lenses that can be machined using a lathe. FIG. 1A illustrates a contact lens, FIG. 1B illustrates a meniscus shaped corneal inlay, FIG. 1C illustrates a pin-hole corneal inlay, and FIG. 1D illustrates a fixed power intraocular lens with haptics. As used herein, machining a lens using a lathe generally refers to cutting at least a portion of each of two sides of the lens (e.g., an anterior surface and a posterior surface) with a lathe cutting tool (e.g., a diamond cutting tool).

A blank, or button, is referred to herein as a workpiece constructed of the raw lens material into which lens surfaces have not yet been machined, and is intended to be subsequently fabricated into a lens. Blanks can be cylindrically shaped, but may have other shapes. As used herein, “workpiece” is a general term, and the terms “blank” and “button” are used to refer to a raw “workpiece” before surfaces have been machined. In some instances, however, the term “button” or “blank” may refer to a workpiece in which one or more non-lens surfaces have been machined, such as for assisting in mounting the button to a lathe.

A common step in lathing a workpiece is to secure the workpiece to an arbor, which is a fixture, usually plastic or metal, that acts to mount the workpiece onto the lathe. The step of joining the workpiece and arbor is generally referred to as “blocking,” and common techniques include blocking by wax, ice, and pressure. The arbor/workpiece assembly is then mounted onto the lathe (i.e., chucked) for machining. A common chucking technique is to clamp the assembly with and within a collet, although other techniques such as vacuum, jaw, and magnetic chucking can also be used.

There are some drawbacks to mounting the workpiece to an arbor (i.e., blocking) during the manufacturing process. First, it is a step that requires securing the two components together, and takes additional time. Blocking also inherently requires an additional de-blocking step, which separates the workpiece or finished part from the arbor fixture. If both side of the workpiece are blocked to an arbor during the manufacturing process, each side of the workpiece must be blocked and de-blocked.

An additional drawback to mounting the workpiece to an arbor is the common misalignment of the two optical surface centerlines (i.e., an imaginary line that runs through the center of a cylindrical or rotating feature). The current state-of-the-art of blocking technology does not allow for ultra-precise alignment of parts to micron tolerances. A centerline as used herein may be also referred to as a rotational axis. Misalignment of the centerlines may be referred to herein generally as de-centering or non-perpendicularity between button and arbor, and may also be referred to herein generally as how much the two surfaces are skewed relative to one another. These misalignment anomalies are also referred to as prism. Any indications of misaligned centerlines can lead to dimensional and optical defects. FIGS. 2A-2E illustrate the concept of centerlines, and FIG. 3 provides an exaggerated occurrence of misalignment of centerlines (i.e., de-centering), which leads to optical defects. FIG. 2A illustrates a side sectional view of an exemplary starting material 10, or button, that is to be machined in the manufacture of a lens. Button 10 is cylindrical, with a first side 12 and a second side 14. In FIG. 2B button 10 has been blocked to arbor 20, such as with wax. Specifically, second side 14 of button 10 is facing arbor 20. FIG. 2C shows the button/arbor assembly clamped into a collet 30 of lathe 40. A surface of arbor 20 is clamped directly in contact with collet 30. Button first side 12 is exposed and ready for a cutting tool to machine first side 12. First side 12 is then machined to form first surface 16 (although some finishing to surface 16 may also be performed), as shown in FIG. 2D. The centerline “C1” (or rotational axis) of surface 16 is illustrated in FIG. 2D. Arbor 20 is then de-blocked from first side 14 of the workpiece shown in FIG. 2D. The workpiece is then blocked again to an arbor (the same or a different arbor as used with the first side), but this time the arbor is facing surface 16. The arbor is then clamped again directly into the collet, this time exposing side 14 for machining. Surface 18 is then machined into side 14, as shown in FIG. 2E (arbor not shown for clarity). Centerline C2 of surface 18 is shown in FIG. 2E. In this example centerlines C1 and C2 are the same line, and surfaces 16 and 18 thus share the same centerline.

FIG. 3 illustrates an exaggerated side sectional view of a workpiece with two surfaces 22 and 24 that have been machined into the workpiece (such as using the process described in reference to FIGS. 2A-2E). As shown, centerline D1 of surface 24 and centerline D2 of surface 22 are de-centered, in contrast to the two centerlines in FIG. 2E. This causes a difference in thickness at the circumference between thickness T1 and thickness T2, with T1 being greater than T2, which causes optical defects. A specification common to ophthalmic lenses is the largest amount of thickness difference along the entire circumference of a lathed part, (often referred to as “prism”). If, based on the specification, the prism is too great, the lens can be considered a defect and is discarded. The amount of prism for the workpiece is influenced by the degree to which the centerlines for the surfaces are misaligned. The prism created in the example in FIG. 3 may be acceptable or it may not, depending on the specifications of the lens being manufactured. Some types of lenses have stricter specification requirements for prism than others, in which case those lenses would greatly benefit from surfaces whose centerlines are as close to perfectly aligned as possible. In general, however, methods that reduce or eliminate prism will generally be preferred to those that result in misaligned centerlines because they will result in better optical quality and fewer defects (products not within specification) during the manufacturing process.

Blocking during the manufacturing process increases the likelihood of de-centered centerlines, which leads to optical defects (such as prism). Blocking also requires additional centerlines to be examined and also requires additional steps performed to a high degree of accuracy, which lengthens and complicates the overall process. Additionally, any misalignment or error with the blocking operation will have a direct effect on the final dimensions of the inlay.

Blocking is also associated with common surface quality defects, which include extensive roughness, pitting (indentations), chatter, scratches, etc., on the lens surfaces. All of these detract from the optical quality and/or require additional steps to compensate for these defects such as finishing steps.

Lens manufacturing techniques are needed that mitigate one or more of the problems described above. Additionally, parts that are lathed can benefit from one or more of the advantages provided herein, even if the part is not a lens.

### SUMMARY OF THE DISCLOSURE

An aspect of this disclosure is a method of machining a workpiece to be manufactured into an ophthalmic lens, comprising mounting a workpiece to a lathe; and while the workpiece is mounted to the lathe, machining a first surface of an ophthalmic lens in a first side of the workpiece and a reference surface in the workpiece; releasing the workpiece from the lathe; re-mounting the workpiece to the lathe by securing the reference surface to the lathe; and machining a second surface of the ophthalmic lens into a second side of the workpiece after re-mounting the workpiece to the lathe, wherein machining a reference surface comprises machining a reference surface that is configured so that the first surface and the second surface have the same centerlines.

In some embodiments of this aspect mounting the workpiece to a lathe comprises clamping the workpiece in direct contact with a collet. Re-mounting the workpiece to the lathe can include clamping the reference surface in direct contact with the collet.

In some embodiments of this aspect machining the reference surface comprises machining an outer cylindrical reference surface in the workpiece. Machining a reference surface can also comprise machining a flat annular reference surface in the first side of the workpiece that is perpendicular to an axis defined by the outer cylindrical reference surface.

In some embodiments of this aspect the method further comprises positioning an adhesive potting compound adjacent the first surface and allowing the adhesive potting compound to harden before re-mounting the workpiece to the lathe. Positioning the adhesive potting compound comprises positioning an adhesive potting compound adjacent the first surface without it extending over a flat peripheral portion of the first surface, which can be a reference surface.

In some embodiments of this aspect the method further comprises cutting the ophthalmic lens from the workpiece, a diameter of the cut ophthalmic lens being less than 70% of an outer cylindrical reference surface diameter, less than 60% of the outer cylindrical reference surface diameter, or less than 50% of the outer cylindrical reference surface diameter.

In some embodiments of this aspect machining a second surface of the ophthalmic lens into a second side of the workpiece forms a central thickness between the first surface and the second surface that is less than 500 microns, less than 400 microns, less than 300 microns, less than 200 microns, less than 100 microns, or less than 50 microns.

In some embodiments of this aspect machining the reference surface into the work piece comprises making a reference surface cut less than 100 microns off an outer edge of the workpiece.

Another aspect of this disclosure is a method of machining a workpiece to be manufactured into an ophthalmic lens, comprising mounting a workpiece to a lathe; and while the workpiece is mounted to the lathe, machining a first surface of an ophthalmic lens in a first side of the workpiece and a reference surface in the workpiece; and positioning an adhesive potting compound adjacent the first surface and allowing the adhesive potting compound to harden; and machining a second surface of the ophthalmic lens into a second side after allowing the adhesive potting compound to harden.

In some embodiments of this aspect positioning an adhesive potting compound adjacent the first surface comprises positioning an adhesive potting compound within a cavity partially defined by the first surface of the ophthalmic lens. Positioning the adhesive potting compound comprises positioning an adhesive potting compound within a cavity partially defined by the first surface of the ophthalmic lens without having the adhesive potting compound extend over a peripheral flat region of the first surface of the workpiece, which can be a reference surface.

In some embodiments of this aspect the method further comprises releasing the workpiece from the lathe before positioning an adhesive potting compound adjacent the first surface; and re-mounting the workpiece to the lathe before machining the second surface.

In some embodiments of this aspect mounting the workpiece to a lathe comprises clamping the workpiece in direct contact with a collet, the method further comprises, at a time after machining the first surface, releasing the workpiece from the lathe, and re-mounting the workpiece to the lathe by clamping the reference surface in direct contact with the collet.

In some embodiments of this aspect machining the reference surface comprises machining an outer cylindrical reference surface in the workpiece. Machining a reference surface can also comprise machining a flat annular reference surface in the first side of the workpiece that is perpendicular to an axis defined by the outer cylindrical reference surface.

In some embodiments of this aspect the method further comprises cutting the ophthalmic lens from the workpiece, a diameter of the cut ophthalmic lens being less than 70% of an outer reference surface diameter, less than 60% of the outer reference surface diameter, or less than 50% of the outer reference surface diameter.

In some embodiments of this aspect machining a second surface of the ophthalmic lens into a second side of the workpiece forms a central thickness between the first surface and the second surface that is less than 500 microns, less than 400 microns, less than 300 microns, less than 200 microns, less than 100 microns, or less than 50 microns.

In some embodiments of this aspect machining a reference surface comprises machining a reference surface that is configured so that the first surface and the second surface have the same centerlines.

In some embodiments of this aspect machining the reference surface into the work piece comprises making a reference surface cut less than 100 microns off an outer edge of the workpiece.

Another aspect of this disclosure is a method of machining a workpiece to be manufactured into an ophthalmic lens, comprising mounting a workpiece to a lathe; and while the workpiece is mounted to the lathe, machining a first surface of an ophthalmic lens in a first side of the workpiece and an outer cylindrical reference surface in the workpiece; and lathing a second surface of the ophthalmic lens in a second side of the workpiece.

In some embodiments of this aspect the method further comprises releasing the workpiece from the lathe after machining the first surface and the reference surface; and re-mounting the workpiece to the lathe before lathing the second surface.

In some embodiments of this aspect mounting the workpiece to a lathe comprises clamping the workpiece in direct contact with a collet, the method further comprising, at a time after machining the first surface, releasing the workpiece from the lathe, and re-mounting the workpiece to the lathe by clamping the reference surface in direct contact with the collet.

In some embodiments of this aspect positioning an adhesive potting compound adjacent the first surface comprises positioning an adhesive potting compound within a cavity partially defined by the first surface of the ophthalmic lens. Positioning the adhesive potting compound can comprise positioning an adhesive potting compound within a cavity partially defined by the first surface of the ophthalmic lens without having the adhesive potting compound extending over a peripheral flat region of the first surface of the workpiece.

In some embodiments of this aspect machining the outer cylindrical reference surface into the work piece comprises making a reference surface cut less than 100 microns from an outer edge of the workpiece.

In some embodiments of this aspect the method further comprises cutting the ophthalmic lens from the workpiece, a diameter of the cut ophthalmic lens being less than 70% of an outer reference surface diameter, less than 60% of the outer reference surface diameter, or less than 50% of the outer reference surface diameter.

In some embodiments of this aspect machining a second surface of the ophthalmic lens into a second side of the workpiece forms a central thickness between the first surface and the second surface that is less than 500 microns, less than 400 microns, less than 300 microns, less than 200 microns, less than 100 microns, or less than 50 microns.

In some embodiments of this aspect machining a reference surface comprises machining a reference surface that is configured so that the first surface and the second surface have the same centerlines.

Another aspect of this disclosure is a method of lathing optical surfaces into a workpiece comprising: lathing anterior and posterior optical surfaces of an ophthalmic lens into a workpiece without securing the workpiece to an arbor, wherein either the anterior surface or the posterior surface is lathed before the other, and wherein the anterior and posterior surfaces of the ophthalmic lens are rotationally symmetric.

In some embodiments of this aspect lathing an anterior optical surface of an ophthalmic lens into a workpiece comprises clamping the workpiece in direct contact with a collet, and wherein lathing a posterior optical surface of an ophthalmic lens into the workpiece comprises clamping the workpiece in direct contact with the collet. The method can also include lathing a reference surface into the workpiece at the same time as lathing one of the anterior and posterior optical surfaces of the ophthalmic lens. Lathing either the anterior optical surface or the posterior optical surface can comprise clamping the reference surface into direct contact with the collet.

In some embodiments of this aspect the method further comprises positioning an adhesive potting compound adjacent one of the lathed anterior and posterior optical surfaces and allowing it to harden. Positioning an adhesive potting compound can comprise positioning an adhesive potting compound within a cavity partially defined by one of the anterior and posterior optical surfaces. Positioning the adhesive potting compound can comprise positioning an adhesive potting compound within a cavity partially defined by one of the anterior and posterior optical surfaces without having the adhesive potting compound extend over a flat region of the first surface of the workpiece.

In some embodiments of this aspect the method further comprises lathing an outer cylindrical reference surface into the work piece at the same time as lathing one of the anterior or posterior optical surfaces. Machining the outer cylindrical reference surface into the work piece can comprise making an annular reference surface cut less than 100 microns from an outer edge of the workpiece.

In some embodiments of this aspect the method further comprises cutting the ophthalmic lens from the workpiece after lathing the anterior and posterior optical surfaces, a diameter of the cut ophthalmic lens being less than 70% of an outer reference surface diameter that has been lathed into the workpiece, less than 60% of the outer reference surface diameter, or less than 50% of the outer reference surface diameter.

In some embodiments of this aspect machining the anterior and posterior optical surfaces of the ophthalmic lens forms a central thickness between the anterior and posterior optical surfaces that is less than 500 microns, less than 400 microns, less than 300 microns, less than 200 microns, less than 100 microns, or less than 50 microns.

In some embodiments of this aspect lathing anterior and posterior optical surfaces of an ophthalmic lens into a workpiece without securing the workpiece to an arbor comprises lathing anterior and posterior optical surfaces of an ophthalmic lens that have the same centerlines.

Another aspect of this disclosure is a method of lathing optical surfaces into a workpiece comprising lathing anterior and posterior optical surfaces of an ophthalmic lens into a workpiece without securing the workpiece to an arbor, wherein lathing the anterior and posterior optical surfaces comprises clamping the workpiece directly to the same collet when lathing both the anterior optical surface and when lathing the posterior optical surface.

In some embodiments of this aspect lathing anterior and posterior optical surfaces of an ophthalmic lens into a workpiece without securing the workpiece to an arbor comprises lathing anterior and posterior optical surfaces of an ophthalmic lens that have the same centerlines. The method can further comprise lathing a reference surface into the workpiece at the same time as lathing one of the anterior and posterior optical surfaces of the ophthalmic lens, wherein lathing one of the anterior and posterior optical surfaces comprises clamping the reference surface in direct contact with the collet.

In some embodiments of this aspect the method further comprises positioning an adhesive potting compound adjacent one of the lathed anterior and posterior optical surfaces and allowing it to harden before lathing the other of the anterior and posterior optical surfaces. Positioning an adhesive potting compound comprises positioning an adhesive potting compound within a cavity partially defined by one of the anterior and posterior optical surfaces. Positioning the adhesive potting compound comprises positioning an adhesive potting compound within a cavity partially defined by one of the anterior and posterior optical surfaces without having the adhesive potting compound extend over a flat peripheral region of the first surface of the workpiece.

In some embodiments of this aspect the method further comprises lathing an outer cylindrical reference surface into the work piece at the same time as lathing one of the anterior and posterior optical surfaces. Machining the outer cylindrical reference surface into the work piece can comprise making an annular reference surface cut less than 100 microns from an outer edge of the workpiece.

In some embodiments of this aspect the method further comprises cutting the ophthalmic lens from the workpiece after lathing the anterior and posterior optical surfaces, a diameter of the cut ophthalmic lens being less than 70% of an outer reference surface diameter that has been lathed into the workpiece, less than 60% of the outer reference surface diameter, or less than 50% of the outer reference surface diameter.

In some embodiments of this aspect machining the anterior and posterior optical surfaces of the ophthalmic lens forms a central thickness between the anterior and posterior optical surfaces that is less than 500 microns, less than 400 microns, less than 300 microns, less than 200 microns, less than 100 microns, or less than 50 microns.

Another aspect of the this disclosure is a method of machining a workpiece to be manufactured into an ophthalmic lens, comprising mounting a workpiece to a lathe; and while the workpiece is mounted to the lathe, machining a first surface of an ophthalmic lens in a first side of the workpiece and a reference surface in the workpiece that is less than 100 microns from an outer edge of the workpiece; and lathing a second surface of the ophthalmic lens in a second side of the workpiece.

In some embodiments of this aspect machining the reference surface comprises machining an outer cylindrical reference surface, and a flat annular reference surface, wherein the flat annular reference surface is orthogonal to an axis defined by the outer cylindrical reference surface.

In some embodiments of this aspect machining the reference surface comprises making a cut less than 75 microns from the workpiece outer edge.

In some embodiments of this aspect machining the reference surface comprises making a cut less than 50 microns from the workpiece outer edge.

In some embodiments of this aspect mounting the workpiece to a lathe comprises clamping the workpiece in direct contact with a collet. Lathing the second surface can comprise clamping the outer cylindrical reference surface in direct contact with the collet.

In some embodiments of this aspect the method further comprises positioning an adhesive potting compound adjacent the first surface and allowing the adhesive potting compound to harden before lathing the second surface. Positioning the adhesive potting compound comprises positioning an adhesive potting compound into a cavity partially defined by the first surface without it extending over a flat peripheral region of the first surface of the workpiece.

In some embodiments of this aspect the method further comprises cutting the ophthalmic lens from the workpiece at a time after lathing the second surface, a diameter of the cut ophthalmic lens being less than 70% of the outer reference surface diameter, less than 60% of the outer reference surface diameter, or less than 50% of the outer reference surface diameter.

In some embodiments of this aspect lathing a second surface of the ophthalmic lens into a second side of the workpiece forms a central thickness between the first surface and the second surface that is less than 500 microns, less than 400 microns, less than 300 microns, less than 200 microns, less than 100 microns, or less than 50 microns.

### BRIEF DESCRIPTION OF THE DRAWINGS

FIGS. 1A-1D illustrate exemplary ophthalmic lenses that can be manufacturing using methods, system, and devices herein.

FIGS. 2A-2E illustrate an exemplary known process for manufacturing ophthalmic lenses.

FIG. 3 illustrates de-centering, or a misalignment of centerlines.

FIGS. 4A-4F illustrate an exemplary method of machining a workpiece.

FIG. 5 illustrates an exemplary workpiece geometry.

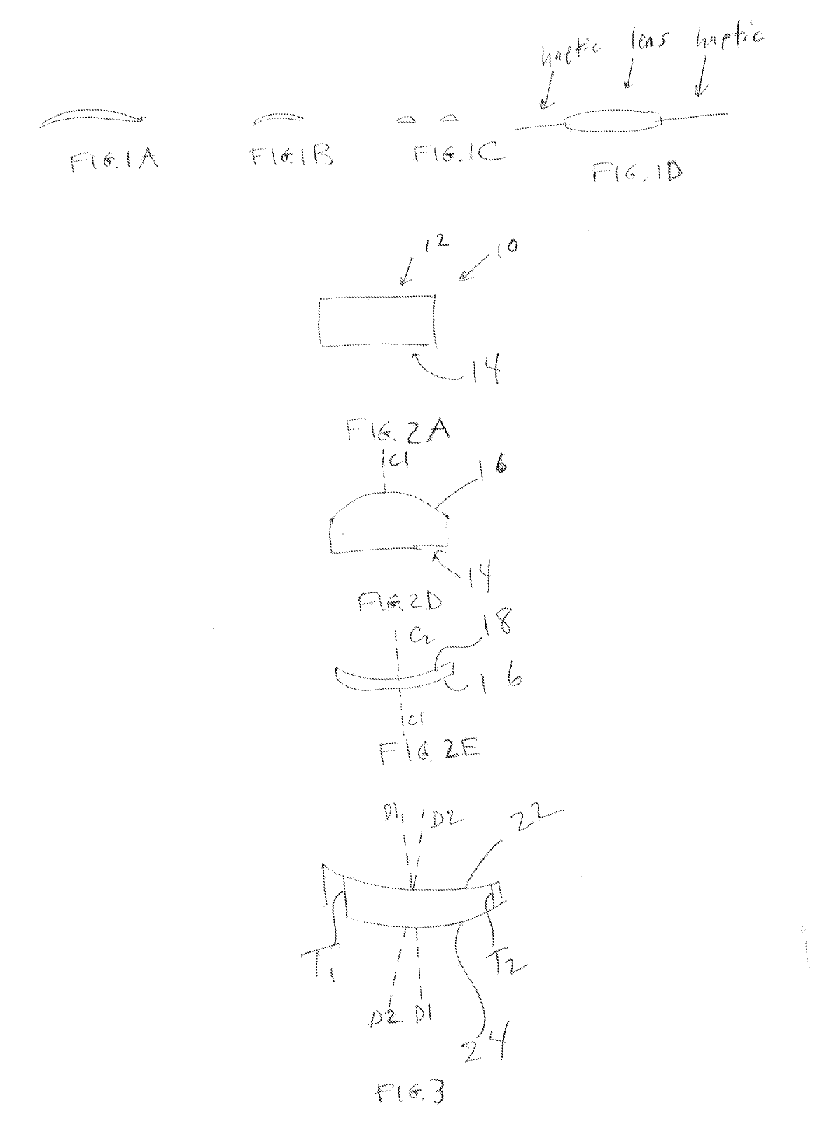

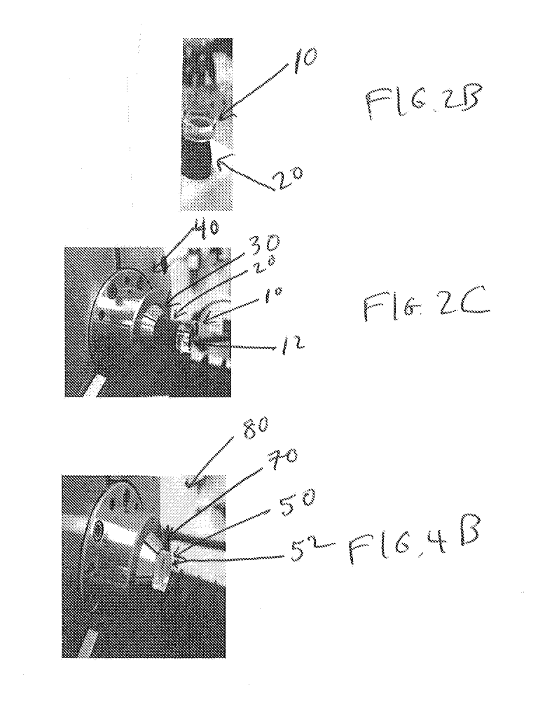

### DETAILED DESCRIPTION

The disclosure herein describes methods, systems, and devices for manufacturing lenses, including without limitation ophthalmic lenses such as contact lenses, spectacle lenses, corneal lenses, and intraocular lenses. The disclosure herein also describes methods, systems, and devices for lathing parts, even if those parts are not lenses. The methods, systems, and devices herein are thus not limited to the manufacture of ophthalmic lenses, or even to the manufacture of lenses. Corneal lenses as used herein include corneal onlays, corneal inlays, and corneal replacement lenses.

As set forth above, some common techniques for lathing an ophthalmological lens result in optical defects such as prism. One aspect of this disclosure is a description of methods and systems that reduce the degree of de-centering that occurs when machining two surfaces of an ophthalmic lens. This can be alternatively stated as increasing the probability that the two lathed surfaces are on the same rotational axis, or centerline. While these methods do not necessary require that the centerlines are perfectly aligned and that the prism is zero, the data provided below indicates excellent results. Lenses manufactured using the methods herein are much closer to being perfectly rotationally symmetric and closer to having no prism than existing techniques. Alternatively, however, the methods herein are not limited to methods of manufacturing in which the lens surfaces are rotationally symmetric. For example, other advantages of the methods herein can be useful when the surfaces are not rotationally symmetric, such as with toric or multi-focal lenses.

An added benefit to some of the methods described herein (while reducing optical defects such as prism and increasing surface quality) is that they can be performed without blocking the workpiece, which reduces the drawbacks of blocking described above. For example, without blocking the overall process is simplified and more efficient.

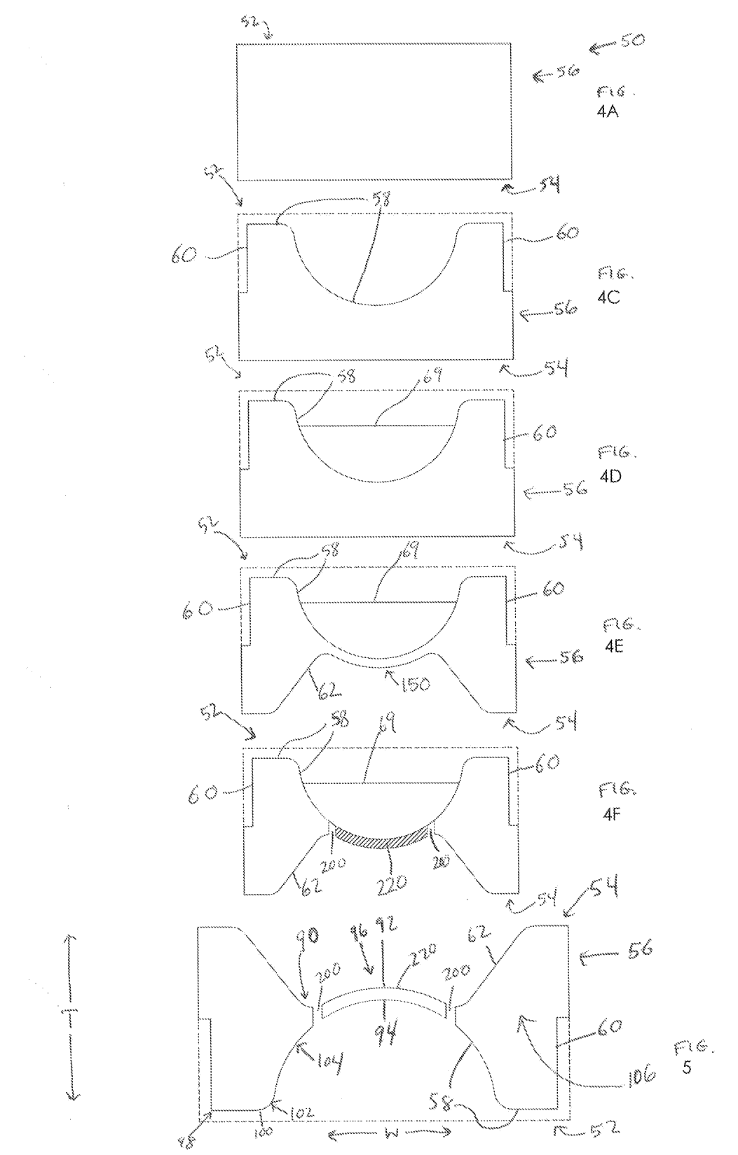

FIGS. 4A-4F illustrate an exemplary method of machining a workpiece that is to be manufactured into an ophthalmic lens (for clarity, FIGS. 4C-4E show workpieces without showing the collet). FIG. 4A illustrates a side sectional view of an exemplary cylindrically shaped workpiece 50 having first side 52, second side 54, and outer edge 56. In FIG. 4A workpiece 50 is a button. FIG. 4B illustrates workpiece 50 chucked onto lathe 80 with side 54 facing the inside of collet 70 and side 52 exposed to the cutting tool. Workpiece 50 has been clamped into direct contact with collet 70 of lathe 80 such that outer edge 56 of button 50 is clamped directly by collet 70. Button outer edge 56 is thus the clamping surface for collet 70. After workpiece 50 has been chucked to lathe 80 as shown in FIG. 4B, first surface 58 and outer reference surface 60 are cut into the workpiece in one cycle by machining side 52 and a portion of outer edge 56. Surfaces 58 and 60 are perfectly concentric to each another and have the same centerlines since they were cut in the workpiece in the same machine cycle. In this embodiment surface 60 and the flat peripheral region of surface 58 are both considered part of the same reference surface, as that term is used herein, and can also individually be characterized as reference surfaces. As used herein, a reference “surface” is not limited to any particular shape or configuration. The flat peripheral region of surface 58 is generally characterized as the region of surface 58 peripheral to the central curved region of surface 58. FIG. 4C shows surfaces 58 and 60 cut into the work piece, as well as the original surfaces of the workpiece shown as dotted lines.

In this embodiment surface 60 is an outer annular surface that defines an axis. While the shape of workpiece in FIG. 4C is not a true cylinder, surface 60 is also considered an outer cylindrical reference surface herein. Surface 60 can also be considered an annular reference surface as that term is used herein, since the surface 60 is annular in shape around the axis. The flat (when viewed in a side view of the workpiece) annular peripheral region of surface 58, which is orthogonal to the axis defined by reference surface 60, is also an annular reference surface in that it has an annular shape in an end-view of the workpiece.

In alternative embodiments reference surface 60 would still be considered an outer cylindrical reference surface even if the workpiece had an inner aperture through the workpiece from the first side all the way through to the second side.

A “reference surface” as used herein generally refers to a surface machined into a workpiece during the same machine cycle as a first surface of the lens, at least a part of which can be used as a reference surface in the machining of a second lens surface. In the embodiment in FIGS. 4A-4F, the reference surfaces 60 and a portion of surface 58 are not optical surfaces of the lens, but in alternative methods one or more portions of the reference surfaces can be an optical surface of the lens. The specific geometry of first surface 58 in this embodiment is described in more detail below. In this embodiment the central curved region of first surface 58 defines a concave surface of the ophthalmic lens. Thus, a portion of lathed surface 58 defines a first surface of the ophthalmic lens, either an anterior or posterior surface of the ophthalmic lens.

After first surface 58 and reference surface 60 have been machined into the workpiece (as shown in FIG. 4C), the workpiece is removed, or released, from the lathe. Since the workpiece was not blocked, a de-blocking step is not performed here. FIG. 4D illustrates an optional but preferred step in which, after the workpiece has been removed from the lathe, potting compound 69 is dispensed within the cavity defined by the central region of surface 58, a portion of which is the first surface of the ophthalmic lens. In some embodiments the potting compound is wax, or another substance that can harden, and is described in more detail below. The potting compound is allowed to harden or set as desired. In the example in FIG. 4D the amount of potting compound is such that it does not extend all the way up to the peripheral flat region of surface 58.

The workpiece shown in FIG. 4D is again chucked onto the lathe (not shown), but the workpiece is now flipped so that side 52 (the original surface of which has been entirely machined away at this point) is now advanced into collet first. The reference surface, which includes surface 60 and the flat annular peripheral region of surface 58 engage the step in the collet, while both surfaces 60 and the flat annular peripheral region of surface 58 are also each individually considered reference surfaces. Surface 60 is the surface to which the collet directly clamps to mount the work piece to the lathe and is the reference surface that establishes concentricity with the collet. The flat annular peripheral region of surface 58 that was previously machined into the workpiece is now the reference surface to which establishes perpendicularity with the collet. The reference surface, which includes surface 60 and the flat annular region of surface 58, ensure that the second surface machined into the second side of the work piece will have the same centerline as the first surface 58, as is described below.

With reference surface 60 clamped to the collet and side 52 of the workpiece facing the inside of the collet, side 54 of the workpiece is exposed to the cutting tool. Side 54 is then machined to create second surface 62 in the workpiece, as shown in FIG. 4E. Second surface 62 includes a central region 150 that is convex, which includes a second surface of the ophthalmic lens.

As shown in FIG. 4F, at some time after second surface 62 is created, a cut 200 is made through the central lens body region 150 (labeled in FIG. 4E) of the workpiece to separate the newly formed lens 220 (in hash marks) from the supporting workpiece. The same tool can be used to separate the lens from the work piece, which provides for exceptional accuracy. Alternatively, a separate tool may be used in order to, for example, limit tool exposure to the potting compound, and/or allow another tool type, and/or reduce wear on a more expensive tool. The lens will still be held in place by the potting compound 69 (e.g., wax), as shown in FIG. 4F. The potting compound bonds the lens 220 to the remaining workpiece and provides rigid support for cutting forces. The potting compound is subsequently removed via a solvent (e.g., water). It is of note that second surface of the ophthalmic lens can, if desired, undergo further processing before the potting compound is removed. For example, the second surface of the ophthalmic lens can be polished and/or exposed to air flow before the potting compound is removed.

The methods herein (e.g., the method of FIGS. 4A-4F) can be used to manufacture a corneal implant, such as a corneal inlay or a corneal onlay. Exemplary corneal implants that can be manufactured using the methods herein can be found in U.S. Pat. No. 8,057,541, issued Nov. 15, 2011; U.S. Pub. No. 2008/0262610, published Oct. 23, 2008; U.S. Pub. No. 2009/0198325, published Aug. 6, 2009; and Pub. No. 2011/0218623, published Sep. 8, 2011, the disclosures of which are incorporated by reference herein.

One of the benefits of some of the exemplary methods herein is that they create two lens surfaces that are more rotationally symmetric compared to existing techniques. Stated alternatively, the centerlines of the two surfaces are more closely aligned than when existing techniques are used. This reduces optical defects such as prism, which is described in more detail herein. While this and other similar methods may not create perfectly rotationally symmetric surfaces, they create much more rotationally symmetric surface than other approaches, as the results and data herein show. In this embodiment the rotationally symmetric surfaces are created by creating a reference surface (which in this embodiment includes surface 60 and the flat peripheral region of surface 58) in the workpiece that has the same centerline as a first machined lens surface and a second machined lens surface. In this embodiment the reference surface is secured to the lathe so that the second lens surface to be machined in the workpiece will have a centerline that is the same as the reference surface centerline. In this manner the first and second lens surfaces that are machined (as well as the reference surface) have the same centerline. Stated alternatively, the first and second lens surface will have the same rotational axis. As stated above, blocking steps are often associated with de-centering, and are typically used when a certain amount of optical defects are acceptable, such as in the manufacturing of contact lenses.

One aspect of the embodiment shown in FIGS. 4A-4F is a method of machining a workpiece to be manufactured into a lens, the method including mounting a workpiece to a lathe, and while the workpiece is mounted to the lathe, machining a first surface of a lens and a reference surface in the workpiece, wherein the reference surface is positioned and adapted to be a reference surface when machining a second surface of the lens.

One aspect of the embodiment shown in FIGS. 4A-4F is a method of machining a workpiece to be manufactured into a lens, the method including mounting a workpiece to a lathe such that a reference surface previously machined into the workpiece is in direct contact with a part of the lathe.

One aspect of the embodiment shown in FIGS. 4A-4F is a method of machining a workpiece to be manufactured into a lens, the method including machining a first surface of a lens and a reference surface in a workpiece while the workpiece is secured to a lathe, releasing the workpiece from the lathe, re-securing the workpiece to the lathe such that the lathe is in direct contact with the reference surface, and machining a second surface of a lens in the workpiece while the workpiece is re-secured to the lathe.

One aspect of the embodiment shown in FIGS. 4A-4F is a method of lathing optical surface into a workpiece without securing the workpiece to an arbor.

One aspect of the embodiment in FIGS. 4A-4F is a method of machining a workpiece to be manufactured into a lens, including, after a first side of a workpiece has been machined, securing the workpiece in direct contact with a part of the lathe, and machining a second side of the workpiece.

One aspect of the embodiment shown in FIGS. 4A-4F is a method of machining a workpiece to be manufactured into a lens, including, subsequent to a first side of a workpiece being machined, machining the second side of the workpiece with a lathe while the workpiece is not secured to an arbor.

One aspect of the embodiment in FIGS. 4A-4F is a method of machining a workpiece to be manufactured into a lens, comprising lathing a posterior surface of a lens into a workpiece without securing the workpiece to an arbor, and lathing an anterior surface of the lens into the workpiece without securing the workpiece to an arbor.

One aspect of the embodiment in FIGS. 4A-4F is a method of machining a workpiece used to be manufactured into a lens, including mounting a workpiece in direct contact with a lathe, lathing a first side of the workpiece, re-orienting the workpiece and re-mounting the workpiece in direct contact with the lathe, and lathing a second side of the workpiece.

One aspect of the embodiment in FIGS. 4A-4F is a method of lathing surfaces into a workpiece comprising lathing first and second sides of a lens without securing the workpiece to an arbor and without inducing distortion into the lens.

Another exemplary advantage of the embodiment in FIGS. 4A-4F is that the workpiece does not need to be blocked to an arbor at any time during any machining steps. This eliminates steps and saves time, decreasing the overall length of the process, improving efficiency and throughput. Contact lenses and intraocular lenses are typically manufactured with at least one blocking step. The methods herein can therefor simplify the manufacturing procedures for contact lenses and intraocular lenses, as well as additional ophthalmic lenses.

As mentioned above, blocking typically reduces the surface quality of the product. Common surface quality defects include extensive roughness, pitting (indentations), chatter, scratches, etc. By removing the blocking operation and removing extra fixturing, the methods of lathing herein are more robust to surface quality. Rather than lathing a stacked assembly (blocked part), lathing a single component reduces undesirable stresses, vibrations, etc. that can contribute to surface defects.

In some embodiments of the methods herein the same collet can be used when machining the first and second sides of the workpiece. This provides a benefit in that the collet does not need to be changed out after machining the first side, which simplifies the overall process. One technique that allows the same collet to be used for both sides is to make a minimal cut when machining reference surface 60 (compared to the diameter of the workpiece before reference surface 60 is cut). By making a minimal cut, reference surface 60 has a diameter that is still large enough to be securely clamped by the same collet, if desired. In some embodiments the minimal cut for reference surface 60 is less than 5 microns, less than 10 microns, less than 15 microns, less than 20 microns, less than 25 microns, less than 30 microns, less than 35 microns, less than 40 microns, less than 45 microns, less than 50 microns, less than 60 microns, less than 70 microns, less than 80 microns, less than 90 microns, or less than 100 microns. In some embodiments the minimal cut for reference surface 60 is about 5 microns (e.g., between 0 and 7.5 microns), about 10 microns (e.g., from 7.5 microns to 12.5 microns), about 15 microns (e.g., from 12.5 microns to 17.5 microns), about 20 microns (e.g., from 17.5 microns to 22.5 microns), about 25 microns (e.g., from 22.5 microns to 27.5 microns), about 30 microns, about 35 microns, about 40 microns, about 45 microns, about 50 microns, about 60 microns, about 70 microns, about 80 microns, about 90 microns, or about 100 microns. In some embodiments sufficient material is cut on reference surface 60 to ensure that the full circumference of the reference surface is annular, or round. In other embodiments, such as for different types of ophthalmic lenses (e.g., spectacle lenses), the cut for a reference surface can have larger dimensions that those described herein. In the embodiment in FIGS. 4A-4F the reference surfaces 60 and 58 are both cut to be annular such that they fit in the step in the same collet used to machine them.

In some embodiments, a different collet can be used when machining the second side of the lens. It may be appropriate, when making a reference cut, to cut significantly more material to create a step or other feature on the outer surface of the workpiece, or reduce the outside diameter to fit a different, smaller, collet.

In some embodiments herein, a reference surface does not have to be cut into the workpiece, and the same collet can still be used for machining both sides. In these embodiments, the first side is machined to create the first surface, but a reference surface is not also made in the workpiece (unlike in the embodiment in FIGS. 4A-4F). After the workpiece is removed from the collet and flipped around, the workpiece outer edge (without a reference surface cut therein) is clamped into the collet. The second side is then machined to create the second surface. Blocking would not be needed in these embodiments, and it might be possible that the requirements for the optical lens would be satisfied even though a reference surface had not been created (e.g., the amount of prism might be acceptable). This is an example of one aspect of the disclosure in which both surfaces can be machined without blocking the workpiece, even if a reference surface is not also created into the workpiece. In these embodiments the same collet can be used for machining both sides.

Similarly, not all methods herein require that the two surfaces be rotationally symmetrical. For example, lenses with non-symmetrical surfaces can be manufactured using techniques herein. Toric and multi-focal lenses are examples of lenses that can be manufactured using methods herein even though the two sides of the lenses are not symmetrical. For example, a toric lens could be manufactured herein without an arbor and without distortion even though the sides of the lens are non-symmetrical.

In embodiments in which a reference surface is cut in the workpiece, the reference surface can comprise of an outer surface of a cylinder (such as outer cylindrical reference surface 60), and/or annular (such as outer cylindrical reference surface 60 and the flat peripheral region of surface 58), such as in the embodiment in FIGS. 4A-4F. A reference surface as described herein is not, however limited to these types of cuts. For example, it is conceivable that the reference surface could take on a variety of configurations, if the reference surface can still be satisfactorily clamped into the same collet or different collet. For example, a different collet could be used for machining the second side if the reference surface has a certain depth or takes on a different configuration, such as a bevel, taper, step, flat, or possibly non-rotationally symmetric geometries. In some embodiments it may be desirable to use a different collet for the second side than the first side. For example, a smaller collet size might provide added stability to the workpiece or allow for a particular geometry to be cut into the workpiece.

Methods herein clamp the workpiece directly to the lathe when machining the second side of the workpiece to create the second surface (rather than blocking the workpiece). One consideration with this technique is making sure the workpiece can withstand the forces applied to it all the way through the machining of the second side. Lathes can operate up to 6000 RPM or faster, and considerable forces can distort or damage the workpiece during the lathing if the geometry of the workpiece is not appropriately configured to withstand such forces. One aspect of this disclosure is thus a workpiece to be used in the manufacture of an ophthalmic lens. The workpiece is an apparatus that has a configuration after a first curve (or first surface) and a second curve (or second surface) have been machined into respective sides of the workpiece that allows the second curve to have been machined while the workpiece is directly clamped to a lathe without an arbor secured to the workpiece. The configurations herein allow the two sides of the workpiece to be machined without an arbor and without inducing significant distortion in the lens. Significant distortion as used herein refers to a physical deformation that can affect dimensional and/or optical attributes such that the lens is not within the tolerances for the particular lens being manufactured. Thus, for a particular lens that is being manufactured, if both sides of the lens are lathed without using an arbor and the lens properties are within the specified tolerances, it has been created without inducing significant distortion. This is how it is known if the lens was manufactured without significant distortion. Distortion can be seen or measured on an interferometer, profilometer, surface analyzer, optical power/resolution bench, and other non-contact metrologies.

FIG. 4E above illustrates an exemplary workpiece geometry after both sides of the work piece have been lathed to form first and second surfaces of the ophthalmic lens. The geometry includes base surface 58 (which may be referred to herein as a first surface, or first curve) and second surface 62. In this embodiment, a central portion of base surface 58 is concave and a central portion of second surface 62 is convex, and a meniscus shaped lens is created from the central region of the workpiece (as described above).

FIG. 5, which illustrates the workpiece after the cut 200 has been made to the workpiece, highlights some aspects of the exemplary workpiece geometry shown in FIGS. 4E and 4F. In FIG. 5 the potting compound is not shown for clarity. Base surface 58 and second surface 62 are again identified (the workpiece is flipped relative to that shown in FIG. 4E). Base surface 58 (the flat peripheral portion of which is part of the reference surface) was created when machining the first side, and second surface 62 was created when machining the second side of the workpiece. Reference surface 60 is also identified. In alternative embodiments surface 62 is machined first (with the optional reference surface), and surface 58 is machined second. In these alternative embodiments reference surface 60 would be on the edge of the workpiece closer to surface 62 rather than surface 58. When discussing the geometry shown in FIG. 5, thicknesses and widths refer to dimensions in the directions “T” and “W,” respectively, that are shown in FIG. 5. The diameter of the workpiece is measured in the width dimension.

In general, the amount that the workpiece is distorted when clamped in the collet can depend on a variety of factors, such as workpiece thickness, minimum thickness of the workpiece, workpiece diameter, collet depth, etc. In the embodiment in FIGS. 4A-4F, wax is dispensed and allowed to harden inside the cavity defined by the central curved region of surface 58, which helps stabilize the workpiece by providing additional temporary mass to the relatively thin central portion of the workpiece. An aspect of the machined profile shown in FIG. 5 is that the peripheral region of the workpiece has enough mass to allow the second surface to be machined while clamped directly to the lathe without distorting the lens. A workpiece geometry with a very thin peripheral region (relative to the diameter), directly clamped by the lathe, would likely cause significant distortion and prevent accurate lathing. Many ophthalmic lenses (e.g., contact lenses) have very thin central thickness, and thus to machine a second side while the workpiece is directly clamped will require enough mass in the peripheral portion to withstand the forces applied by lathing without distorting the workpiece.

The workpiece geometry shown in FIG. 5 is an exemplary geometry of a workpiece that has a configuration after a first curve and a second curve have been machined into respective sides of the workpiece that allows the second curve to have been machined while the workpiece is directly secured to a lathe without an arbor secured to the workpiece. Cutting programs are used for the base and second curves, respectively.

Lead-in region 90 (radially outward relative to the final lens) is generally flattened and provides enough mass of remaining material of high compressive strength to prevent distortion under cutting forces. In this embodiment the convex surface 92 of the meniscus is cut after the concave surface 94. The dome shape provides high compressive stiffness to prevent tool chatter and part distortion, as the cutting forces are distributed through lead-in region 90.

The lens body region 96 is retained with a minimal thickness of supporting material to distribute the torsional and compressive cutting forces to region 90. In some exemplary embodiments the thickness of central lens region is less than 200 microns. In some embodiments the thickness of central lens region is less than 190 microns, less than 180 microns, less than 170 microns, less than 160 microns, less than 150 microns, less than 140 microns, less than 130 microns, less than 120 microns, less than 110 microns, less than 100 microns, less than 90 microns, less than 80 microns, less than 70 microns, less than 60 microns, less than 50 microns, less than 40 microns, less than 30 microns, less than 20 microns, less than 15 microns, less than 10 microns, or less than 5 microns.

As is described above, in this exemplary embodiment the diameter of reference surface 60 is machined to match the inside diameter of the collet in which the workpiece was placed when machining the base curve. The same collet can thus be used to machine both sides. The contact area between the collet and the workpiece is therefore maximized to distribute the collet clamping forces and minimize part distortion. The required collet clamping force is also minimized to take advantage of maximized clamping surface area.

The outside corner radius 98, machined with the base curve, provides inside-corner collet clearance, reduces high corner stress, prevents creation of edge particles, and prevents injury to an operator's skin and/or gloves.

As mentioned above, all of the surfaces of base surface 58 (the flat peripheral region of which is part of the reference surface) and reference surface 60 are cut in one cycle. All of the base surface 58 surfaces and reference surface 60 are cut perfectly concentric to each other. The distance from surface 100 (which is the flat annular peripheral region of surface 58) to the central apex at surface 94, in the thickness “T” direction, is a fixed value and is controlled precisely. Maintaining a fixed value for this distance is important for final thickness control of the central lens body region 96.

The inside corner 102 radius reduces high corner stress, prevents creation of edge particles, and prevents injury to an operator's skin and/or gloves.

The primary lead-in geometry 104 provides sufficient depth for a potting compound (e.g., wax). This radial geometry also provides for tool cutter clearance and sufficient clearance for swarf-removal air jets. These air jets ensure that no swarf remains on the tool or cutting surface, which would have caused material scuffing or rings on the part surfaces. The overall bowl geometry provides for smooth air flow to enhance swarf removal, and subsequently provides a nearly particle-free final surface. Surface finish after lathing is optimized and provides excellent optical properties without polishing. Polishing can, however, also be performed if desired.

The supporting mass 106 of the peripheral portion is sufficiently large enough to absorb the compressive clamping forces and the torsional cutting forces (without an arbor) and prevent finished-part distortion. Preventing distortion in the finished part is an important consideration when designing the periphery of the workpiece.

As an example, in some embodiments the diameter of reference surface 60 is about 3 mm to about 150 mm, the thickness of the central lens body region (such as region 96 in FIG. 5) is at least 5 microns, and the thickness of peripheral region 106 measured from side 52 to side 54 is between about 1 mm and 50 mm. In some embodiments the central thickness of lens body region 96 is between 5 microns and about 50 microns, and in some embodiments is between 5 microns and 200 microns.

In embodiments herein the peripheral region 106 thickness is greater than thickness of the lens body region. For some types of lenses the thicknesses and widths of the lathed workpiece may differ from the examples herein. For example, for spectacle lenses the peripheral region dimensions and/or central thickness dimensions may be much greater but the concepts described herein still apply.

One aspect of the disclosure, an example of which is shown in FIGS. 4A-4F, and also the workpiece shown in FIG. 5, is a method of machining a workpiece used in the manufacture of an ophthalmic lens, comprising lathing a first surface into a first side of a workpiece, and lathing a second surface into a second side of a workpiece, wherein lathing the second surface creates a central thickness between the first and second surfaces that is less than 200 microns, and an outer edge thickness that is at least 500 microns. In some embodiments the central thickness is less than 150 microns, less than 140 microns, less than 130 microns, less than 120 microns, less than 110 microns, less than 100 microns, less than 90 microns, less than 80 microns, less than 70 microns, less than 60 microns, less than 50 microns, less than 40 microns, less than 30 microns, less than 25 microns, less than 20 microns, less than 15 microns, less than 10 microns, or less than 5 microns.

The cuts on both sides of the workpiece can be machined with algorithms that control the cutting path of the cutting tool. One aspect of the disclosure is an automated process for machining a workpiece used in the manufacture of an ophthalmic lens, comprising an automated process for lathing a workpiece used in the manufacture of an ophthalmic lens, the automated process adapted to control a cutting tool to machine a second curve into a second side of the workpiece, the process for cutting the second surface adapted to create a central thickness between a first surface and the second surface that is less than 200 microns and an outer edge that is at least 500 microns, and a processing component adapted to store the automated process, wherein the processing component is configured to control the cutting tool.

The disclosure herein refers to machining surfaces of a lens into a workpiece. Even though the “surface” is said to be machined, it does not necessary mean that the “surface” is the final, or finished, ophthalmic lens surface. The “surface” can undergo any additional processing that may be desired. For example, the surface may undergo polishing, air flow, or other post-machining treatments to, for example, improve the surface. Even if the “surface” undergoes one or more post-machining treatments, the machined surface is still considered to be a “surface” of the lens, as that language is used herein. For example, a second surface of the lens can undergo further processing before or after a potting compound is removed from a workpiece.

### Example 1

59 ophthalmic lenses were manufactured without blocking according to the method generally described above in FIGS. 4A-4F. A primary consideration was the prism that occurred in these lenses, which is described as the largest amount of thickness difference along the entire circumference of the manufactured lens. The ophthalmic lenses that were manufactured in this example were corneal inlays configured to correct presbyopia, exemplary methods of which are described in U.S. Pub. No. 2011/0218623, published Sep. 8, 2011, which is incorporated by reference herein. The edge thickness and lens diameter were measured using Nikon measurement systems. For these lenses, no prism was greater than 1 micron. Different types of ophthalmic lenses can have different acceptable prisms depending on the tolerances for the lens being manufactured. Contact lenses, for example, can have a greater tolerance for prism than small corneal inlays.

Over 7 days, out of the 59 inlays produced, the prism did not exceed 1 micron for the 59 lenses, as is illustrated in Table 1. Lens diameters were measured and ranged from about 1 mm to about 3 mm. The two measurements for prism in Table 1 represent the smallest and largest thicknesses measured around the circumference of the lens.

TABLE 1

| Inlay # | Prism |
|---|---|
| 1 | 0 |
| 2 | 0 |
| 3 | 0 |
| 4 | 1 |
| 5 | 1 |
| 6 | 0 |
| 7 | 1 |
| 8 | 0 |
| 9 | 0 |
| 10 | 0 |
| 11 | 0 |
| 12 | 0 |
| 13 | 0 |
| 14 | 1 |
| 15 | 1 |
| 16 | 1 |
| 17 | 1 |
| 18 | 0 |
| 19 | 1 |
| 20 | 1 |
| 21 | 0 |
| 22 | 0 |
| 23 | 1 |
| 24 | 0 |
| 25 | 0 |
| 26 | 0 |
| 27 | 0 |
| 28 | 0 |
| 29 | 1 |
| 30 | 1 |
| 31 | 0 |
| 32 | 1 |
| 33 | 1 |
| 34 | 0 |
| 35 | 0 |
| 36 | 1 |
| 37 | 0 |
| 38 | 1 |
| 39 | 1 |
| 40 | 0 |
| 41 | 1 |
| 42 | 0 |
| 43 | 0 |
| 44 | 1 |
| 45 | 0 |
| 46 | 0 |
| 47 | 1 |
| 48 | 1 |
| 49 | 0 |
| 50 | 0 |
| 51 | 0 |
| 52 | 1 |
| 53 | 0 |
| 54 | 1 |
| 55 | 1 |
| 56 | 0 |
| 57 | 1 |
| 58 | 0 |
| 59 | 1 |

### Example 2

A verification process was carried out, and the results are shown in Table 2. 45 corneal inlays were manufactured, and the first 4 were corneal inlays were considered as setup. Out of the following 41 inlays, there were 28 acceptable inlays for a 68% yield.

TABLE 2

| Inlay # | Prism |
|---|---|
| 1 | N/A |
| 2 | N/A |
| 3 | 1 |
| 4 | 0 |
| 5 | 0 |
| 6 | 2 |
| 7 | 0 |
| 8 | 0 |
| 9 | 0 |
| 10 | 0 |
| 11 | 2 |
| 12 | 0 |
| 13 | 0 |
| 14 | 0 |
| 15 | 0 |
| 16 | 0 |
| 17 | 0 |
| 18 | 0 |
| 19 | 0 |
| 20 | 1 |
| 21 | 1 |
| 22 | N/A |
| 23 | 0 |
| 24 | 0 |
| 25 | 1 |
| 26 | 2 |
| 27 | 0 |
| 28 | 0 |
| 29 | 1 |
| 30 | 0 |
| 31 | 1 |
| 32 | 1 |
| 33 | 0 |
| 34 | 0 |
| 35 | 0 |
| 36 | 0 |
| 37 | 0 |
| 38 | 0 |
| 39 | 1 |
| 40 | 0 |
| 41 | 0 |
| 42 | 0 |
| 43 | 0 |
| 44 | 0 |
| 45 | 1 |

As set forth above, the methods herein can be used in the manufacture of any type of machined part. Exemplary parts are lenses such as ophthalmic lenses, including contact lenses and corneal inlays. For example, the blocking process and arbors could be eliminated as described herein in the manufacture of contact lenses or spectacle lenses. For example, for contact lenses or spectacles, the button size (e.g., diameter) can be scaled up, and the tool paths (i.e., the cutting path) modified to include supporting geometry (i.e., peripheral) beyond the central lens area. Blocking material (e.g., wax or other adhesive) could be selected for use as a supportive potting compound for the second-side lathing as is described in the exemplary methods herein.

The methods described herein can be excellent low-cost alternatives to vacuum chucks, as precise and unique vacuum chuck designs are generally required (particularly to provide material support for second-side lathing). A liquid potting compound perfectly conforms to nearly any shape at very little cost.

What is claimed is:

1. A method of machining a workpiece to be manufactured into an ophthalmic lens, comprising:
mounting a workpiece to a lathe; and
while the workpiece is mounted to the lathe, machining a first surface of an ophthalmic lens in a first side of the workpiece and a reference surface in the workpiece;
releasing the workpiece from the lathe;
re-mounting the workpiece to the lathe by securing the reference surface to the lathe; and
machining a second surface of the ophthalmic lens into a second side of the workpiece after re-mounting the workpiece to the lathe,
wherein machining a reference surface comprises machining a reference surface that is configured so that the first surface and the second surface have the same centerlines.

2. The method of claim 1 wherein mounting the workpiece to a lathe comprises clamping the workpiece in direct contact with a collet.

3. The method of claim 2 wherein re-mounting the workpiece to the lathe comprising clamping the reference surface in direct contact with the collet.

4. The method of claim 1 wherein machining the reference surface comprises machining an outer cylindrical reference surface in the workpiece.

5. The method of claim 4 wherein machining the reference surface further comprises machining a flat annular surface in the first side of the workpiece that is perpendicular to an axis defined by the outer cylindrical reference surface.

6. The method of claim 1 further comprising positioning an adhesive potting compound adjacent the first surface and allowing the adhesive potting compound to harden before re-mounting the workpiece to the lathe.

7. The method of claim 6 wherein positioning the adhesive potting compound comprises positioning an adhesive potting compound adjacent the first surface without it extending over the first side of the workpiece.

8. The method of claim 1 further comprising cutting the ophthalmic lens from the workpiece, a diameter of the cut ophthalmic lens being less than 70% of an outer cylindrical reference surface diameter.

9. The method of claim 8 wherein the diameter of the ophthalmic lens is less than 60% of the outer cylindrical reference surface diameter.

10. The method of claim 8 wherein the diameter of the ophthalmic lens is less than 50% of the outer cylindrical reference surface diameter.

11. The method of claim 1 wherein machining a second surface of the ophthalmic lens into a second side of the workpiece forms a central thickness between the first surface and the second surface that is less than 500 microns.

12. The method of claim 11 wherein machining a second surface of the ophthalmic lens into a second side of the workpiece forms a central thickness between the first surface and the second surface that is less than 400 microns.

13. The method of claim 11 wherein machining a second surface of the ophthalmic lens into a second side of the workpiece forms a central thickness between the first surface and the second surface that is less than 300 microns.

14. The method of claim 11 wherein machining a second surface of the ophthalmic lens into a second side of the workpiece forms a central thickness between the first surface and the second surface that is less than 200 microns.

15. The method of claim 11 wherein machining a second surface of the ophthalmic lens into a second side of the workpiece forms a central thickness between the first surface and the second surface that is less than 100 microns.

16. The method of claim 11 wherein machining a second surface of the ophthalmic lens into a second side of the workpiece forms a central thickness between the first surface and the second surface that is less than 50 microns.

17. The method of claim 1 wherein machining the reference surface into the work piece comprises making an annular reference surface cut less than 100 microns off an outer edge of the workpiece.

18. A method of machining a workpiece to be manufactured into an ophthalmic lens, comprising:
mounting a workpiece to a lathe;
while the workpiece is mounted to the lathe, machining a first surface of an ophthalmic lens in a first side of the workpiece and a reference surface in the workpiece;
positioning an adhesive potting compound adjacent the first surface and allowing the adhesive potting compound to harden; and
machining a second surface of the ophthalmic lens into a second side after allowing the adhesive potting compound to harden.

19. A method of machining a workpiece to be manufactured into an ophthalmic lens, comprising:
mounting a workpiece to a lathe; and
while the workpiece is mounted to the lathe, machining a first surface of an ophthalmic lens in a first side of the workpiece and an outer cylindrical reference surface in the workpiece; and
lathing a second surface of the ophthalmic lens in a second side of the workpiece.

20. A method of lathing optical surfaces into a workpiece comprising:
lathing anterior and posterior optical surfaces of an ophthalmic lens into a workpiece without securing the workpiece to an arbor, wherein either the anterior surface or the posterior surface is lathed before the other, and wherein the anterior and posterior surfaces of the ophthalmic lens are rotationally symmetric.

21. A method of lathing optical surfaces into a workpiece comprising:
lathing anterior and posterior optical surfaces of an ophthalmic lens into a workpiece without securing the workpiece to an arbor, wherein lathing the anterior and posterior optical surfaces comprises clamping the workpiece directly to the same collet when lathing both the anterior optical surface and when lathing the posterior optical surface.
